(19) United States
(12) Patent Application Publication
(10) Pub. No.: US 2019/0055951 A1
(43) Pub. Date: Feb. 21, 2019

(54) Fan and power source system and method

(71) Applicant: Darrin Jacobs, Pasadena, MD (US)

(72) Inventor: Darrin Jacobs, Pasadena, MD (US)

(21) Appl. No.: 15/998,667

(22) Filed: Aug. 15, 2018

Related U.S. Application Data
(60) Provisional application No. 62/545,998, filed on Aug. 15, 2017.

(51) Int. Cl. F04D 25/06; H02S 40/38; H02J 7/00; H02J 7/35; F04D 29/60; F04D 29/00; F04D 25/08

(52) U.S. Cl. CPC F04D 25/0673; H02S 40/38; H02J 7/0052; H02J 7/35; F21S 9/032; F04D 29/005; F04D 25/08; H02J 2007/0062; F04D 29/601

(57) ABSTRACT

A fan and power source system including a power source, at least one outlet integrated with the power source for charging an external device, a photovoltaic array, a fan, and a fastening mechanism. The fan and power source system is useful not only for circulating air, but also for charging external devices. The photovoltaic array is disposed on said power source, and is able to convert solar energy into electricity, which is subsequently stored in the power source. The fan has an impeller configured to move air. The impeller is driven by a motor powered by the power source. The fastening mechanism is configured to removably attach the fan and power source system to a structure.

### CROSS-REFERENCE TO RELATED APPLICATION(S)

The present application is related to and claims priority to U.S. Provisional Patent Application No. 62/545,998 filed Aug. 15, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of fans of existing art and more specifically relates to portable fans.

### RELATED ART

Many people use fans to circulate air, in order to reduce the perceived temperature of a space. Circulating air about a person's body helps evaporate sweat from a person's skin, thereby increasing the person's comfort level. A fan useful for this application may utilize a rotating arrangement of vanes or blades which directs airflow using a motor.

Working or relaxing outdoors can lead to people becoming hot and then suffering from dizziness, heat strokes, and other dangerous conditions. Cooling the body can be difficult without a fan or air conditioning. Some people may abandon necessary tasks during the summer months, such as mowing the lawn, if it is too hot outside. Unfortunately, many available fans are too bulky or require stationary power sources, making outdoor use of them impractical. A suitable solution is desired.

U.S. Pat. No. 7,455,582 to Cody G. Barrett relates to a solar powered fan for portable enclosure. The described solar powered fan for portable enclosure includes an electrical fan, which is pivotally mounted within the interior region of a portable edifice, such as that associated with a portable toilet facility. The pivotal mounting of the fan allows for selective user adjustment of the angular position of the fan with respect to the roof of the housing. Mounted on the roof, exterior to the enclosure, is a hollow housing having at least one solar panel mounted to an upper surface thereof. The solar panel charges a rechargeable battery received within the hollow housing which, in turn, is in electrical communication with the electrical fan.

### SUMMARY OF THE INVENTION

In view of the foregoing disadvantages inherent in the known portable fan art, the present disclosure provides a novel fan and power source system and method. The general purpose of the present disclosure, which will be described subsequently in greater detail, is to provide an effective and efficient fan and power source system and method.

A fan and power source system is disclosed herein. The fan and power source system includes a power source, at least one outlet integrated with the power source for charging an external device, a photovoltaic array, a fan, and a fastening mechanism. The fan and power source system is useful not only for circulating air, but also for charging external devices. The photovoltaic array is disposed on said power source, and is able to convert solar energy into electricity, which is subsequently stored in the power source. The fan has an impeller configured to move air. The impeller is driven by a motor powered by the power source. The fastening mechanism is configured to removably attach the fan and power source system to a structure.

According to another embodiment, a method of using a fan and power source system is also disclosed herein. The method of using a fan and power source system includes providing the above-described fan and power source system; attaching the fan to the power source; attaching the fan and power source system to a structure; activating the fan with a button; and optionally, charging the power source via a micro-USB port.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a fan and power source system and method, constructed and operative according to the teachings of the present disclosure.

FIG. 1 is a perspective view of the fan and power source system during an ‘in-use’ condition, according to an embodiment of the disclosure.

FIG. 2 is a perspective view of the fan and power source system of FIG. 1, according to an embodiment of the present disclosure.

FIG. 3 is a perspective view of the fastening mechanism of the fan and power source system of FIG. 1, according to an embodiment of the present disclosure.

FIG. 4 is a perspective view of the fan and power source system of FIG. 1, according to an embodiment of the present disclosure.

FIG. 5 is a flow diagram illustrating a method of use for charging devices and circulating air, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a portable fan and more particularly to a fan and power source system and method as used to improve the circulation of air while also providing a power source for charging external devices.

Generally, the system includes a fan driven by a motor, a power bank comprising a rechargeable battery, a solar panel array able to charge the power bank, and a fastening mechanism for releasably attaching the fan to a structure. In various embodiments, these components may be separable, or they may be contained in a unitary housing. In a preferred embodiment, the fan has three blades having an overall diameter of approximately seven inches and utilize a direct-current motor operable at five volts. Preferably, the power bank is a five-volt battery suitable for driving the five-volt motor. The fastening mechanism may be a spring-loaded clamp having two jaws. Preferably, the jaws are sized to clamp around a round fixture up to two inches in diameter.

In a kit embodiment, the system may be additionally provided with a mini-USB one-hundred-and-twenty volt wall charger and a mini-USB twelve-volt car charger each able to charge the power bank, a three-to-one USB adapter cable for converting one USB socket to three USB sockets, a drawstring bag, a protective casing for the power bank, at least one additional clip or fastening mechanism for suspending the power bank, or any combination thereof.

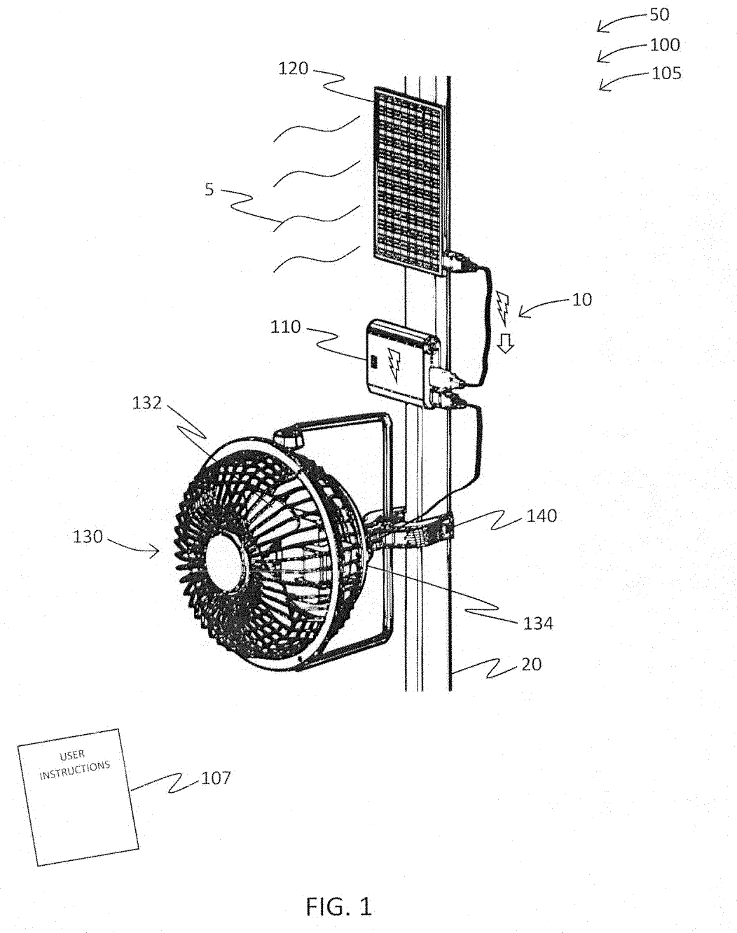

Referring now more specifically to the drawings by numerals of reference, there is shown in FIGS. 1-4, various views of a fan and power source system 100.

FIG. 1 shows a fan and power source system during an ‘in-use’ condition 50, according to an embodiment of the present disclosure. Here, the fan and power source system may be beneficial for use by a user to charge devices and circulate air. As illustrated, the fan and power source system 100 may include power source 100, photovoltaic array 120, fan 130, and fastening mechanism 140. Photovoltaic array 120, may be disposed on power source 110, and may be configured to convert solar energy 5 into electricity 10 stored in power source 110. Fan 130 may have impeller 132. Impeller 132 may be configured to move air and may be driven by a motor 134. Motor 134 may be powered by power source 110. Fastening mechanism 140 may be configured to retain fan and power source system 100 to structure 20. Fastening mechanism 140 may be able to clamp around a structure 20. Fan and power source system 100 may be useful both for providing power to auxiliary devices and for circulating air.

According to one embodiment, the fan and power source system 100 may be arranged as a kit 105. In particular, the fan and power source system 100 may further include a set of instructions 107. The instructions 107 may detail functional relationships in relation to the structure of the fan and power source system 100 such that the fan and power source system 100 can be used, maintained, or the like, in a preferred manner.

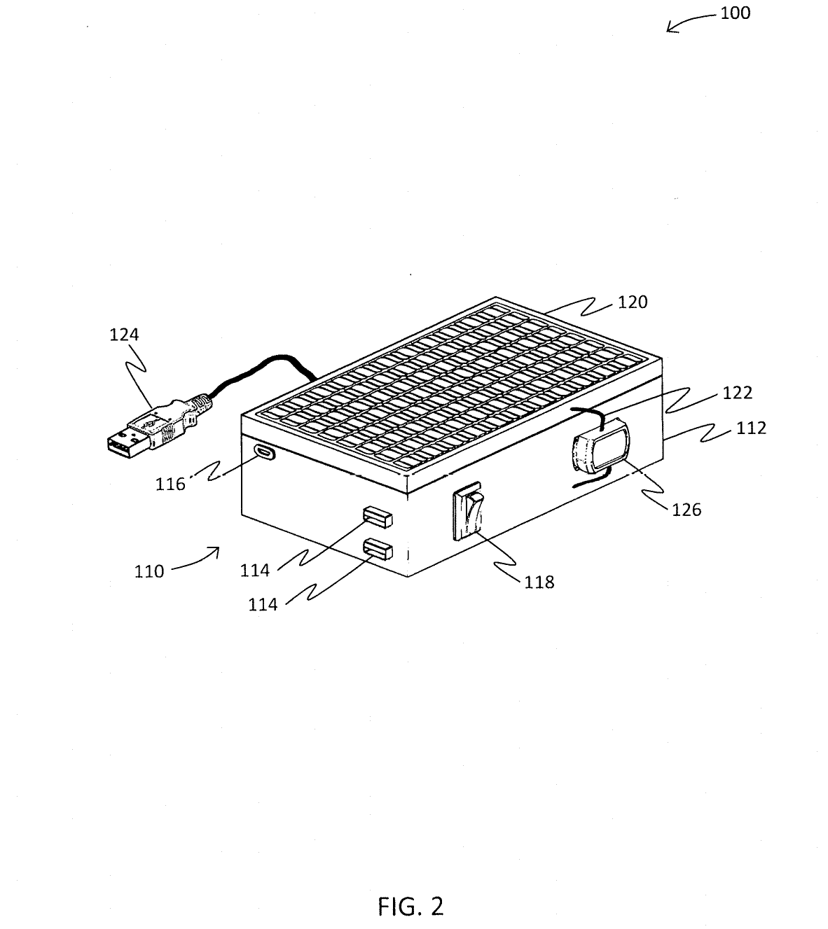

FIG. 2 shows the fan and power source system 100 of FIG. 1, according to an embodiment of the present disclosure. As above, the fan and power source system 100 may include power source 110, photovoltaic 120, and fastening mechanism 140. Fan and power source system 100 may further comprise wiring 122. Wiring 122 may enable electrical communication between power source 110, photovoltaic array 120, and fan 130. Fan and power source system 100 may also further comprising charge controller 126. Charge controller 126 may regulate flow of electricity 10 (FIG. 1) from photovoltaic source 120 to power source 110. In one embodiment, charge controller 126 may restrict current flow from photovoltaic source 120 to power source 110.

Photovoltaic array 120 may be connected in parallel, series, and alternatively, a combination of parallel and series in various embodiments. Photovoltaic array 120 comprises monocrystalline silicon. Power source 110 comprises at least one lithium-ion battery and may have a minimum capacity of 12,000 mAh. Power source 110 and photovoltaic array 120 may be enclosed in protective casing 112. Proactive casing 112 may join power source 110 and photovoltaic array 120 as a unitary component in some embodiments. In yet other embodiments, protective casing 112 may join motor 134 (FIG. 1), power source 110, and photovoltaic array 120 as a unitary component. Fan 130 (FIG. 1) may include USB plug 124. USB plug 124 may be configured draw power from a conventional USB port. Power source 110 may further include micro-USB port 116, power source 110 being configured to be charged via micro-USB port 116. Fan and power system 100 may further include at least one outlet 114 integrated with power source 110, at least one outlet 114 being configured to charge an external device. Preferably, power source 110 includes a plurality of USB ports. At least one outlet 114 may be configured to accept USB plug 124 and may be able to provide electricity 10 (FIG. 1) stored within power source 110 to fan 130 (FIG. 1) or other external devices. For example, at least one outlet 114 may be useful for charging mobile devices. Power source 110 may also include switch 118. Switch 118 may be configured to enable and alternatively disable fan 130. In various embodiments, switch 118 may be a push-button, a rotary switch, or another type of switch mechanism.

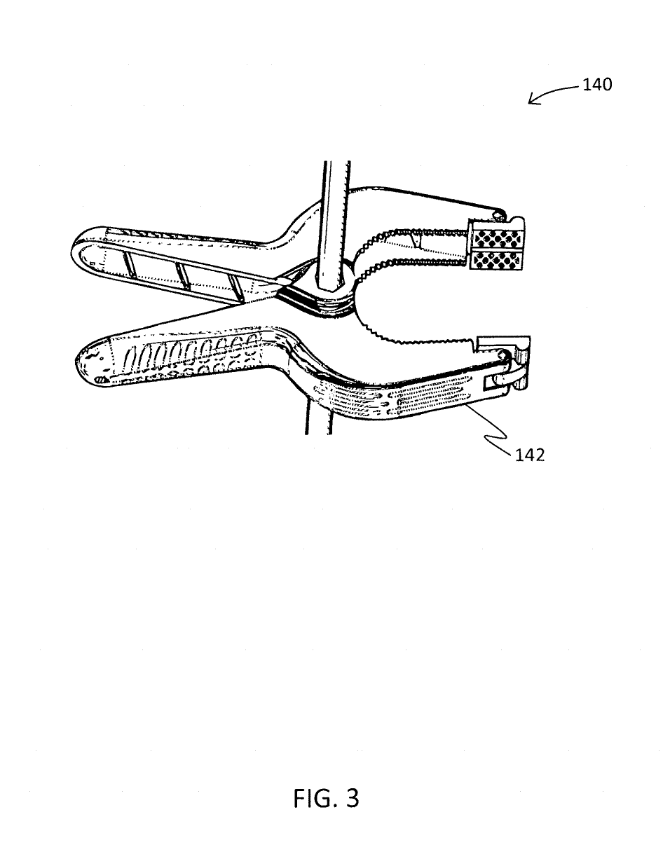

FIG. 3 is a perspective view of the fastening mechanism of the fan and power source system 100 of FIG. 1, according to an embodiment of the present disclosure. Fastening mechanism 140 is spring-powered clamp 142. In some embodiments, spring-powered clamp 142 may be mounted to fan 130 (FIG. 1) via a mounting arm. Spring-powered clamp 142 may be integral to the mounting arm. Fastening mechanism 140 may be able to be retained to structure 20 (FIG. 1) by spring pressure. Spring-powered clamp 142 may further include a pair of handles for releasing spring pressure.

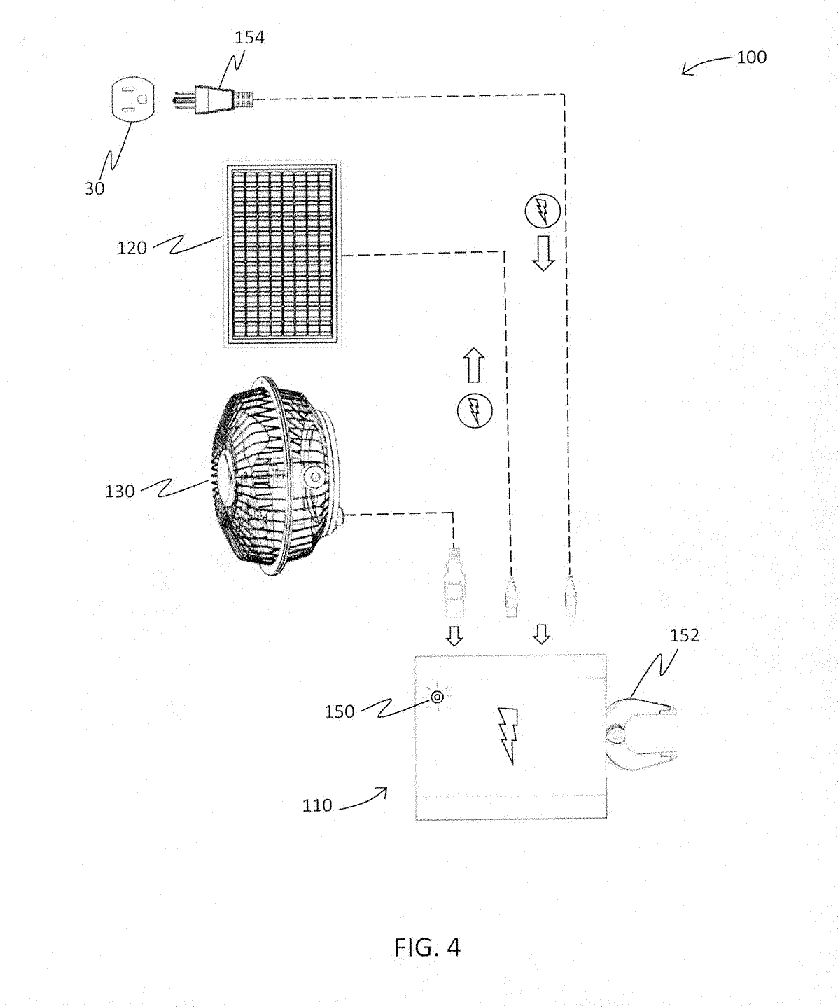

FIG. 4 is a perspective view of the fan and power source system 100 of FIG. 1, according to an embodiment of the present disclosure. Fan and power source system 100 may further comprise power cord 154 able to interface with a 120-volt power source 30, power cord 154 having a NEMA 1-type plug or a NEMA 5-type plug. Power cord 154 may be in electrical communication with power source 110 and may be configured to charge power source 110. Power cord 154 may be used as a charging alternative to mini-USB port 116 (FIG. 2). In some embodiments, power cord 154 may include a voltage regulator configured to regulate power delivered to power source 110. Power source 110 includes mounting-clip 152. Fan and power source system 100 further comprise safety-light 150 as shown. Safety-light 150 may be configured to draw electricity 10 (FIG. 1) from power source 110 and provide illumination. Upon reading this specification, it should be appreciated that, under appropriate circumstances, considering such issues as user preferences, design preference, structural requirements, marketing preferences, cost, available materials, technological advances, etc., other structural arrangements such as, for example, additional retention devices and features, alternative fan blade structures, various housing shapes, etc., may be sufficient.

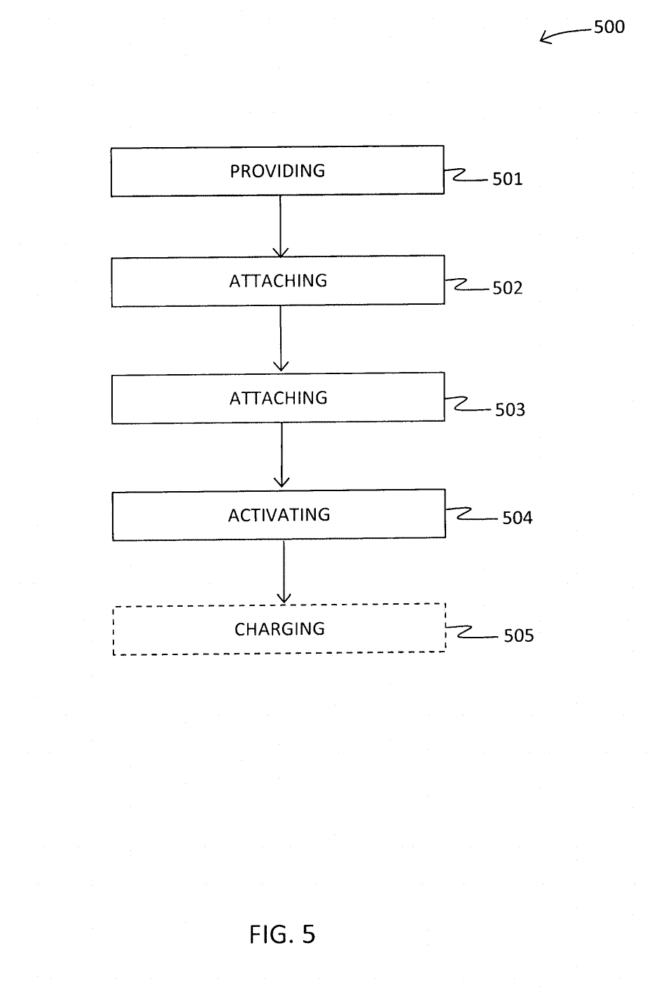

FIG. 5 is a flow diagram illustrating a method of using 500 a fan and power source system 100, according to an embodiment of the present disclosure. In particular, the method for using 500 a fan and power source system 100 may include one or more components or features of the fan and power source system 100 as described above. As illustrated, the method for using 500 a fan and power source system 100 may include the steps of: step one 501, providing the tan and power source system; step two 502, attaching the fan to the power source; step three 503, attaching the fan and power source system to a structure; step four 504, activating the fan by activating a switch; and step five 505, charging said power source via a micro-US B port.

It should be noted that step 505 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for charging devices and circulating air, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A fan and power source system useful for providing power to auxiliary devices and for circulating air, the fan and power source system comprising:
a power source;
at least one outlet integrated with the power source, the at least one outlet being configured to charge an external device;
a photovoltaic array, said photovoltaic array disposed on said power source, said photovoltaic array configured to convert solar energy into electricity stored in said power source;
a fan, said fan having an impeller configured to move air, said impeller driven by a motor, wherein said motor is powered by said power source; and
a fastening mechanism configured to retain said fan and power source system to a structure.

2. The fan and power source system of claim 1, further comprising wiring, said wiring enabling electrical communication between said power source, said photovoltaic array, and said fan.

3. The fan and power source system of claim 1, further comprising a charge controller.

4. The fan and power source system of claim 1, further comprising a power cord able to interface with a 120 volt power source, the power cord having a NEMA 1-type plug and alternatively a NEMA 5-type plug.

5. The fan and power source system of claim 1, wherein said power source includes a mounting-clip.

6. The fan and power source system of claim 1, further comprising a safety-light, said safety-light configured to draw power from said power source and provide illumination.

7. The fan and power source system of claim 1, wherein said photovoltaic array is connected in parallel, series, and alternatively, a combination of parallel and series.

8. The fan and power source system of claim 1, wherein said photovoltaic array comprises monocrystalline silicon.

9. The fan and power source system of claim 1, wherein said power source comprises at least one lithium-ion battery.

10. The fan and power source system of claim 1, wherein said fan includes a USB plug, said USB plug being configured draw power from a conventional USB port.

11. The fan and power source system of claim 1, wherein said power source has a minimum capacity of 12,000 mAh.

12. The fan and power source system of claim 1, wherein said fastening mechanism is a spring-powered clamp.

13. The fan and power source system of claim 1, wherein said power bank includes a switch, said switch being configured to enable and alternatively disable said fan.

14. The fan and power source system of claim 1, wherein said power source and said photovoltaic array are enclosed in a protective casing.

15. The fan and power source system of claim 1, wherein said power bank further includes a micro-USB port, said power bank being configured to be charged via said micro-USB port.

16. The fan and power source system of claim 1, wherein said at least one outlet includes a plurality of USB ports.

17. A photovoltaic fan and power source system useful for providing power to auxiliary devices and for circulating air, the photovoltaic fan and power source system comprising:
a power source;
at least one outlet integrated with the power source, the at least one outlet being configured to charge an external device;
a photovoltaic array, said photovoltaic array disposed on said power source, said photovoltaic array configured to convert solar energy into electricity stored in said power source;
a fan, said fan having an impeller configured to move air, said impeller driven by a motor, wherein said motor is powered by said power source; and
a fastening mechanism configured to retain said system to a structure;
wherein said fan and power source system is useful for providing a mobile power-bank and forced air cooling device;
further comprising wiring, said wiring creating an electrical communication between said power source, said photovoltaic array, and said fan;
further comprising a charge controller;
wherein said power source includes a mounting-clip;
further comprising a safety-light, said safety-light configured to draw power from said power source and provide illumination;
wherein said photovoltaic array is connected in parallel, series, and alternatively, a combination of parallel and series;
wherein said photovoltaic array comprises monocrystalline silicon;
wherein said power source comprises lithium-ion batteries;
wherein said fan is configured draw power from a conventional USB port;
wherein said power source has a minimum capacity of 12,000 mAh;
wherein said fastening mechanism is a spring-powered clamp;
wherein said power bank includes a button, configured to enable, and alternatively, disable said fan;
wherein said power source and said photovoltaic array are enclosed in a protective casing;
wherein said power bank is configured to be charged through a micro-USB port; and
wherein said at least one outlet includes a plurality of USB ports.

18. The fan and power source system of claim 17, further comprising set of instructions; and
wherein the fan and power source system is arranged as a kit.

19. A method of using a fan and power source system, the method comprising the steps of:
providing said fan and power source system;
attaching said fan to said power source;
attaching said fan and power source system to a structure; and
activating said fan with a button.

20. The method of claim 19, further comprising the steps of
charging said power source via a micro-USB port.
